(19) United States
(12) Patent Application Publication
(10) Pub. No.: US 2004/0054026 A1
(43) Pub. Date: Mar. 18, 2004

(54) Elastomeric, expandable hydrogel compositions

(76) Inventors: Jay F. Kunzler, Canandaigua, NY (US); Joseph C. Salamone, Fairport, NY (US)

Correspondence Address: BAUSCH & LOMB INCORPORATED, ONE BAUSCH & LOMB PLACE, ROCHESTER, NY, 14604-2701, US

(21) Appl. No.: 10/246,242

(22) Filed: Sep. 18, 2002

(51) Int. Cl. C08K 3/00; C07F 7/04; B29D 11/00

(52) U.S. Cl. 523/106; 556/465

(57) ABSTRACT

Optically transparent, soft, flexible, elastomeric, expandable hydrogel compositions and ophthalmic devices such as intraocular lenses, contact lenses and corneal inlays made therefrom are described herein. The preferred hydrogel compositions are produced through the copolymerization of one or more fluoro side-chain methacrylate end-capped silicone monomers with one or more hydrophilic monomers.

### FIELD OF THE INVENTION

The present invention relates to materials useful in the manufacture of biocompatible medical devices. More particularly, the present invention relates to elastomeric, expandable hydrogel compositions, which are soft and foldable both in the unhydrated and hydrated states, useful in the manufacture of ophthalmic devices.

### BACKGROUND OF THE INVENTION

Since the 1940's ophthalmic devices in the form of intraocular lens (IOL) implants have been utilized as replacements for diseased or damaged natural ocular lenses. In most cases, an intraocular lens is implanted within an eye at the time of surgically removing the diseased or damaged natural lens, such as, for example, in the case of cataracts. For decades, the preferred material for fabricating such intraocular lens implants was poly(methyl methacrylate), which is a rigid, glassy polymer.

Softer, more flexible IOL implants have gained in popularity in more recent years due to their ability to be compressed, folded, rolled or otherwise deformed. Such softer IOL implants may be deformed prior to insertion thereof through an incision in the cornea of an eye. Following insertion of the IOL in an eye, the IOL returns to its original pre-deformed shape due to the memory characteristics of the soft material. Softer, more flexible IOL implants as just described may be implanted into an eye through an incision that is much smaller, i.e., less than 4.0 mm, than that necessary for more rigid IOLs, i.e., 5.5 to 7.0 mm. A larger incision is necessary for more rigid IOL implants because the lens must be inserted through an incision in the cornea slightly larger than the diameter of the inflexible IOL optic portion. Accordingly, more rigid IOL implants have become less popular in the market because larger incisions have been found to be associated with an increased incidence of postoperative complications, such as induced astigmatism.

With recent advances in small-incision cataract surgery, increased emphasis has been placed on developing soft, foldable materials suitable for use in artificial IOL implants. In general, the materials of current commercial IOLs fall into one of three general categories: silicones, hydrophilic acrylics and hydrophobic acrylics.

In general, high water content hydrophilic acrylics, or “hydrogels,” have relatively low refractive indices, making them less desirable than other materials with respect to minimal incision size. Low refractive index materials require a thicker IOL optic portion to achieve a given refractive power. Silicone materials may have a higher refractive index than high-water content hydrogels, but tend to unfold explosively after being placed in the eye in a folded position. Explosive unfolding can potentially damage the corneal endothelium and/or rupture the natural lens capsule and associated zonules. Low glass transition temperature hydrophobic acrylic materials are desirable because they typically have a high refractive index and unfold more slowly and more controllably than silicone materials. Unfortunately, low glass transition temperature hydrophobic acrylic materials, which contain little or no water initially, may absorb pockets of water in vivo causing light reflections or “glistenings.” Furthermore, it may be difficult to achieve ideal folding and unfolding characteristics due to the temperature sensitivity of some acrylic polymers.

Because of the noted shortcomings of current polymeric materials available for use in the manufacture of ophthalmic implants, there is a need for stable, biocompatible polymeric materials having desirable physical characteristics and refractive indices.

### SUMMARY OF THE INVENTION

Soft, foldable, high refractive index, elastomeric, expandable hydrogel compositions of the present invention are produced through the polymerization or copolymerization of one or more fluoro side-chain methacrylate end-capped silicone monomers with varying concentrations of a hydrophilic monomer. The subject silicone monomers are synthesized through a multi-step reaction scheme. The hydrogel compositions produced from the fluoro side-chain methacrylate end-capped silicone monomers and hydrophilic monomers have ideal physical properties for the manufacture of ophthalmic devices including a reduced friction “Teflon™-like” (E. I. DuPont de Nemours and Company, Wilmington, Del.) surface in the dry state. The hydrogel compositions of the present invention are likewise transparent, of relatively high strength for durability during surgical manipulations, of relatively high elongation, of relatively high refractive index and are biocompatible. The subject hydrogel compositions are particularly well suited for use as intraocular lens (IOLs) implants because the presence of fluoro groups in the material prevents self adherence when the IOL is folded for implantation. The subject hydrogel compositions are likewise well suited for use as contact lenses, keratoprostheses, corneal rings, corneal inlays and the like.

Preferred fluoro side-chain methacrylate end-capped silicone monomers for use in preparing the hydrogel compositions of present invention have the generalized structure represented by Formula 1 below,

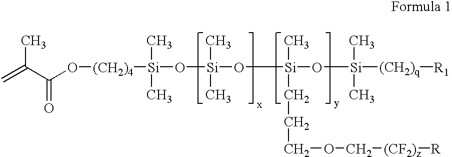

wherein R is selected from the group consisting of hydrogen and fluorine; R₁ is an activated unsaturated polymerizable group; x is an integer less than 51; y is an integer less than 101; z is an integer less than 21; and q is an integer less than 11.

Accordingly, it is an object of the present invention to provide transparent, hydrogel compositions having desirable physical characteristics for the manufacture of ophthalmic devices.

Another object of the present invention is to provide hydrogel compositions of relatively high refractive index.

Another object of the present invention is to provide hydrogel compositions suitable for use in the manufacture of intraocular lens implants.

Another object of the present invention is to provide hydrogel compositions that are biocompatible.

Another object of the present invention is to provide hydrogel compositions suitable for use as contact lens materials.

Still another object of the present invention is to provide hydrogel compositions that are economical to produce.

These and other objectives and advantages of the present invention, some of which are specifically described and others that are not, will become apparent from the detailed description and claims that follow.

### DETAILED DESCRIPTION OF THE INVENTION

The present invention relates to novel fluoro side-chain methacrylate end-capped silicone monomers synthesized through a multi-step reaction scheme. The subject fluoro side-chain methacrylate end-capped silicone monomers are useful in the production of biocompatible hydrogel compositions. The subject hydrogel compositions have particularly desirable physical properties. The subject hydrogel compositions have a relatively high refractive index of approximately 1.35 or greater in the hydrated state and a relatively high expansion upon hydration of approximately 15 to 45 percent or greater. Likewise, the subject hydrogel compositions are soft and flexible in both unhydrated and hydrated states and in the unhydrated state possess a reduced friction “Teflon™-like” surface for ease of insertion. Also, the presence of fluoro groups in the subject hydrogel compositions prevents self-adherence when the IOL implant is folded for implantation. Accordingly, the subject hydrogel compositions are ideal for use in the manufacture of ophthalmic devices. The fluoro side-chain methacrylate end-capped silicone monomers of the present invention are generally represented by Formula 1 below:

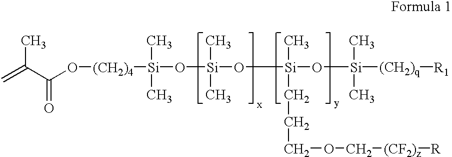

wherein R is selected from the group consisting of hydrogen and fluorine; R₁ is an activated unsaturated polymerizable group selected from the group consisting of methacrylates, methacrylamides, vinyl carbamates and maleonates; x is an integer less than 51; y is an integer less than 101; z is an integer less than 21; and q is an integer less than 11.

Examples of fluoro side-chain methacrylate end-capped silicone monomers of the present invention include for example but are not limited to methacrylate end-capped polymethylsiloxanes containing varying mole percentages of trifluoropropyl, 3-(2,2,3,3-tetrafluoropropoxy)propyl, 3-(2,2,3,3,4,4,5,5-octafluoropentoxy)propyl and 3-(2,2,3,3,4,4,5,5,6,6,7,7-dodecafluorotridecoxy)propyl side-chains.

Fluoro side-chain methacrylate end-capped silicone monomers of the present invention may be synthesized through a multi-step ring opening/hydrosilation reaction scheme as represented in Scheme 1 below:

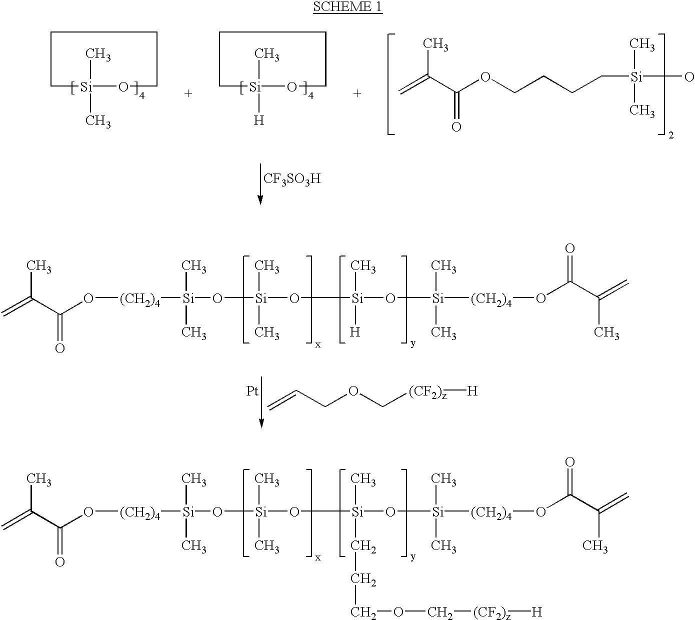

One or more fluoro side-chain methacrylate end-capped silicone monomers of the present invention produced as described above is preferably copolymerized with one or more hydrophilic monomers in accordance with the present invention to produce a hydrogel composition useful in the manufacture of ophthalmic medical devices.

Examples of suitable hydrophilic monomers useful for copolymerization with one or more fluoro side-chain methacrylate end-capped silicone monomers of the present invention include for example but are not limited to N,N-dimethylacrylamide, acrylamide, acrylic acic, 2-hydroxyethyl methacrylate, glyceryl methacrylate, N-vinylpyrrolidone, diacetone acrylamide, 2acrylamido-2-methylpropanesulfonic acid and its salts, 2-(meth)acryloyloxyethylsulfonic acid and its salts, 3-(meth)acryloyloxypropylsulfonic acid and its salts, styrenesulfonic acid and its salts, carboxystyrene and its salts, 3-(meth)acrylamidopropyl-N,N-dimethylamine and its salts, 2-(meth)acryloylethyl-N,N-dimethylamine and its salts and methacrylic acid but preferably N,N-dimethylacrylamide for increased hydrophilicity.

The physical and mechanical properties of hydrogels produced from formulations based on methacrylate end-capped tetrafluoro, octafluoro and dodecafluoro side-chain siloxanes (F—Si) with N,N-dimethylacrylamide (DMA) are set forth below in Table 1.

TABLE 1
Mechanical and physical property results for copolymers based on
DP100 methacrylate end-capped tetrafluoro, octafluoro and
dodecafluoro side-chain siloxanes (F—Si) with DMA.
All formulations contain 0.5% Darocur ™
1173 (EM Industries) as UV initiator.

| Composition | | % | Modulus | Tensile | Tear |
|---|---|---|---|---|---|
| F—Si/DMA | % Loss | Water | g/mm² | g/mm² | g/mm |
| 25 mole % tetra | | | | | |
| 80/20 | 6.3 | 18 | 191 | 30 | 3.2 |
| 70/30 | 2.0 | 31 | 166 | 46 | 3.3 |
| 65/35 | 3.3 | 39 | 161 | 40 | 3.6 |
| 60/40 | 8.9 | 45 | 160 | 57 | 3.8 |
| 25 mole % octa | | | | | |
| 100/0 | 12.0 | 0.1 | 55 | 18 | 1.5 |
| 90/10 | 8.6 | 6 | 188 | 48 | 1.5 |
| 80/20 | 7.2 | 18 | 219 | 48 | 3.3 |
| 75/25 | 6.8 | 26 | 222 | 44 | 4.1 |
| 70/30 | 5.7 | 31 | 210 | 68 | 3.1 |
| 40 mole % octafluoro | | | | | |
| 80/20 | 8.4 | 28.7 | 146 | 57.5 | 3.7 |
| 75/25 | 9.9 | 26.8 | 146 | 49.2 | 3.6 |
| 70/30 | 8.5 | 34.1 | 160 | 49.0 | 3.8 |
| 65/35 | 9.1 | 38.0 | 131 | 50 | 4.2 |
| 60/40 | 8.3 | 44.0 | 126 | 57 | 4.0 |
| 40 mole % dodecafluoro | | | | | |
| 100 | 7.5 | 0.1 | | | |
| 80/20 | 10.7 | 22.7 | 138 | 34 | 2.3 |
| 70/30 | 10.3 | 34.4 | 163 | 57 | 2.7 |
| 60/40 | 9.5 | 49.8 | 142 | 63 | 3.1 |

The physical and mechanical properties of copolymers based on methacrylate end-capped octafluoro side-chain siloxanes (F—Si) with N,N-dimethylacrylamide (DMA) and N-vinylpyrrolidone (NVP) are set forth below in Table 2.

TABLE 2
Mechanical and physical property results for copolymers based on the
DP100 methacrylate end-capped octafluoro side-chain siloxanes
(F—Si) with DMA and NVP. All formulations contain 0.2%
hydroxyethyl vinylcarbonate and 20 parts of hexanol.

| Composition | | | Modulus | Tensile | Tear |
|---|---|---|---|---|---|
| F—Si/DMA/NVP | % Loss | % Water | g/mm² | g/mm² | g/mm |
| 80/20/0 | 22 | 17 | 155 | 55 | 1.8 |
| 80/15/5 | 23 | 16 | 170 | 60 | 1.9 |
| 80/10/10 | 21 | 15 | 195 | 53 | 2.4 |
| 80/5/15 | 23 | 16 | 190 | 45 | 2.0 |
| 70/0/30 | 19 | 28 | 173 | 52 | 2.1 |
| 70/20/10 | 20 | 25 | 180 | 58 | 2.7 |
| 70/10/20 | 21 | 25 | 170 | 46 | 2.3 |
| 70/1/29 | 31 | 19 | 154 | 35 | 1.8 |
| 70/0/30 | 34 | 17 | 146 | 27 | 1.5 |
| 60/40/0 | 16 | 38 | 204 | 57 | 2.2 |
| 60/30/10 | 15 | 35 | 222 | 64 | 2 |
| 60/20/20 | 18 | 34 | 215 | 53 | 1.9 |
| 60/10/30 | 19 | 32 | 213 | 45 | 2.3 |
| 50/10/40 | 24 | 46 | 170 | 45 | 2.3 |

The relationship between percent water and lens expansion versus parts DMA in the fluoro side-chain DMA copolymers are set forth below in Table 3.

[image]

High water content hydrogel compositions, of 15 percent or higher water content by volume, of the present invention having ideal physical characteristics for use in the manufacture of ophthalmic devices are described herein. In the production of such hydrogel compositions of the present invention, one or more fluoro side-chain methacrylate end-capped silicone monomers of the present invention are copolymerized with one or more hydrophilic monomers to form crosslinked three-dimensional networks. However, one or more crosslinking agents may be added in quantities less than 10 percent weight per volume (W/V) to the fluoro side-chain methacrylate end-capped silicone monomer(s), if desired, prior to copolymerization thereof.

Examples of suitable crosslinking agents include but are not limited to diacrylates and dimethacrylates of tetraethylene glycol, triethylene glycol, butylene glycol, neopentyl glycol, hexane-1,6-diol, thio-diethylene glycol and ethylene glycol, poly(ethylene glycol), trimethylolpropane triacrylate, N,N′-dihydroxyethylene bisacrylamide, diallyl phthalate, triallyl cyanurate, divinylbenzene; ethylene glycol divinyl ether, N,N′-methylene-bis(meth)acrylamide, divinylbenzene and divinylsulfone.

Although not required, fluoro side-chain methacrylate end-capped silicone monomers within the scope of the present invention may optionally have one or more strengthening agents added thereto prior to copolymerization thereof, preferably in quantities of less than about 80 weight percent but more typically from about 20 to about 60 weight percent.

Examples of suitable strengthening agents are described in U.S. Pat. Nos. 4,327,203, 4,355,147 and 5,270,418, each incorporated herein in its entirety by reference. Specific examples, not intended to be limiting, of such strengthening agents include cycloalkyl acrylates and methacrylates, such as for example tert-butylcyclohexyl methacrylate and isopropylcyclopentyl acrylate.

One or more ultraviolet light absorbers may optionally be added to the subject fluoro side-chain methacrylate end-capped silicone monomers prior to copolymerization thereof in quantities typically less than 2 percent W/V. Suitable ultraviolet light absorbers for use in the present invention include for example but are not limited to β-(4-benzotriazoyl-3-hydroxyphenoxy)ethyl acrylate, 4-(2-acryloyloxyethoxy)-2-hydroxybenzophenone, 4-methacryloyloxy-2hydroxybenzophenone, 2-(2′-methacryloyloxy-5′-methylphenyl)benzotriazole, 2-(2′-hydroxy-5′-methacryloyloxyethylphenyl)-2H-benzotriazole, 2-[3′-tert-butyl-2′hydroxy-5′-(3″-methacryloyloxypropyl)phenyl]-5-chlorobenzotriazole, 2-(3′-tert-butyl-5′-(3″-dimethylvinylsilylpropoxy)-2′-hydroxyphenyl]-5-methoxybenzotriazole, 2-(3′-allyl-2′-hydroxy-5′-methylphenyl)benzotriazole, 2-[3′-tert-butyl-2′-hydroxy-5′-(3″-methacryloyloxypropoxy)phenyl]-5-chlorobenzotriazole wherein β-(4-benzotriazoyl-3-hydroxyphenoxy)ethyl acrylate is the preferred ultraviolet light absorber.

The fluoro side-chain methacrylate end-capped silicone monomers of the present invention may be readily cured in cast shapes, as discussed in more detail below, by one or more conventional methods. Such methods include for example but are not limited to ultraviolet light polymerization, visible light polymerization, microwave polymerization, thermal polymerization, free radical thermal polymerization or combinations thereof.

One or more suitable free radical thermal polymerization initiators may be added to the monomers of the present invention. Examples of such initiators include for example but are not limited to organic peroxides, such as acetyl peroxide, lauroyl peroxide, decanoyl peroxide, stearoyl peroxide, benzoyl peroxide, tert-butyl peroxypivalate, peroxydicarbonate, and the like. Preferably such an initiator is employed in a concentration of approximately 0.01 to 1 percent by weight of the total monomer mixture.

Representative ultraviolet light initiators include those known in the field such as for example but not limited to benzoin methyl ether, benzoin ethyl ether, Darocur™ 1173, 1164, 2273, 1116, 2959, 3331 (EM Industries) and Irgacur™ 651 and 184 (Ciba-Geigy, Basel, Switzerland).

The hydrogel compositions of the present invention are of relatively high refractive index and relatively high expansion. The hydrogel compositions of the present invention with the desirable physical properties noted above are particularly useful in the manufacture of ophthalmic devices such as but not limited to relatively thin, foldable intraocular lens implants, contact lenses and corneal inlays.

IOLs having relatively thin optic portions are critical in enabling a surgeon to minimize surgical incision size. Keeping the surgical incision size to a minimum reduces intraoperative trauma and postoperative complications. A relatively thin IOL optic portion is also critical for accommodating certain anatomical locations in the eye such as the anterior chamber and the ciliary sulcus. IOLs may be placed in the anterior chamber for increasing visual acuity in either aphakic or phakic eyes, or placed in the ciliary sulcus for increasing visual acuity in phakic eyes. The hydrogel compositions of the present invention are particularly well suited for the manufacture of intraocular lenses due to the same remaining soft and flexible with a reduced friction surface in an unhydrated state. Intraocular lenses manufactured from the subject hydrogel compositions are ideally suited for small incision cataract surgery.

The hydrogel compositions of the present invention have the flexibility required to allow implants manufactured from the same to be folded or deformed in the unhydrated state for insertion into an eye through the smallest possible surgical incision, i.e., 3.0 mm or smaller. It is unexpected that the subject hydrogel compositions could possess the ideal physical properties described herein. The physical properties of the subject polymeric compositions are ideal because lenses made therefrom do not adhere when rolled or folded as would be done for purposes of implantation within an eye, unlike non-fluorinated siloxanes, and possesses excellent recovery characteristics. Also, the surface of reduced friction characteristics aids in surgical implantation when using a cartridge inserter or similar surgical device.

The subject fluoro side-chain methacrylate end-capped silicone monomers and polymeric compositions produced therefrom are described in still greater detail in the examples that follow.

### EXAMPLE 1

### Preparation of Copolymer Based on DP100 Methacrylate End-Capped poly[3-(2,2,3,3,4,4,5,5-octafluoropentoxy)propylmethylsiloxane]-co-(dimethylsiloxane)

A formulation consisting of 70 parts of a DP100 synthesis of methacrylate end-capped poly (25 mole percent) 3-(2,2,3,3,4,4,5,5-octafluoropentoxy)propylmethylsiloxane-co-(75 mole percent) (dimethylsiloxane), 30 parts N,N-dimethylacrylamide and 0.5 percent Darocur™ 1173 as the UV initiator was cast into 1 mm thick films by UV initiated polymerization. The resultant 3 inch by 5 inch films were cut into 20 mm discs and were extracted in isopropanol for 16 hours. The discs were dried overnight under 20 mm Hg vacuum at 90° C. for 16 hours and cut into lens shape by cryo-lathing techniques. The lenses were optically clear and possessed excellent handling characteristics. In the dry state the lenses were capable of being folded into a “taco shell” or a cylindrical shape. These lenses when placed into a borate buffer solution immediately expanded and the lens shape was recovered.

### EXAMPLE 2

### Preparation of Copolymer Based on DP100 methacrylate End-Capped poly[3-(2,2,3,3,4,4,5,5-octafluoropentoxy)propylmethylsiloxane]-co-(dimethylsiloxane)

A formulation consisting of 80 parts of a DP100 synthesis of methacrylate end-capped poly (25 mole percent) 3-(2,2,3,3,4,4,5,5-tetrafluoropentoxy)propylmethylsiloxane-co-(75 mole percent) (dimethylsiloxane), 20 parts N,N-dimethylacrylamide and 0.5 percent Darocur™ 1173 as the UV initiator was cast into 1 mm thick films by UV initiated polymerization. The resultant 3 inch by 5 inch films were cut into 20 mm discs and were extracted in isopropanol for 16 hours. The discs were dried overnight under 20 mm Hg vacuum at 90° C. for 16 hours and cut into lens shape by cryo-lathing techniques. The lenses were optically clear and possessed excellent handling characteristics. In the dry state the lenses were capable of being folded into a “taco shell” or a cylindrical shape. These lenses when placed into a borate buffer solution immediately expanded and the lens shape was recovered.

### EXAMPLE 3

### Preparation of Copolymer Based on DP100 Methacrylate End-Capped poly[3-(2,2,3,3-tetrafluoropropoxy)propylmethylsiloxane]-co-(dimethylsiloxane)

A formulation consisting of 70 parts of a DP100 synthesis of methacrylate end-capped poly (25 mole percent) 3-(2,2,3,3-tetrafluoropropoxy)propylmethylsiloxane-co-(75 mole percent) (dimethylsiloxane), 30 parts N,N-dimethylacrylamide and 0.5 percent Darocur™ 1173 as the UV initiator was cast into 1 mm thick films by UV initiated polymerization. The resultant 3 inch by 5 inch films were cut into 20 mm discs and were extracted in isopropanol for 16 hours. The discs were dried overnight under 20 mm Hg vacuum at 90° C. for 16 hours and cut into lens shape by cryo-lathing techniques. The lenses were optically clear and possessed excellent handling characteristics. In the dry state the lenses were capable of being folded into a “taco shell” or a cylindrical shape. These lenses when placed into a borate buffer solution immediately expanded and the lens shape was recovered.

### EXAMPLE 4

### Preparation of Copolymer Based on DP100 methacrylate End-Capped poly[3-(2,2,3,3-tetrafluoropropoxy)propylmethylsiloxane]-co-(dimethylsiloxane)

A formulation consisting of 60 parts of a DP100 synthesis of methacrylate end-capped poly (25 mole percent) 3-(2,2,3,3-tetrafluoropropoxy)propylmethylsiloxane-co-(75 mole percent) (dimethylsiloxane), 40 parts N,N-dimethylacrylamide and 0.5 percent Darocur™ 1173 as the UV initiator was cast into 1 mm thick films by UV initiated polymerization. The resultant 3 inch by 5 inch films were cut into 20 mm discs and were extracted in isopropanol for 16 hours. The discs were dried overnight under 20 mm Hg vacuum at 90° C. for 16 hours and cut into lens shape by cryo-lathing techniques. The lenses were optically clear and possessed excellent handling characteristics. In the dry state the lenses were capable of being folded into a “taco shell” or a cylindrical shape. These lenses when placed into a borate buffer solution immediately expanded and the lens shape was recovered.

### EXAMPLE 5

### Preparation of Copolymer Based on DP100 Methacrylate End-Capped poly[3-(2,2,3,3,4,4,5,5,6,6,7,7-dodecafluorotridecoxy)propylmethylsiloxane]-co-(dimethylsiloxane)

A formulation consisting of 70 parts of a DP100 synthesis of methacrylate end-capped poly (25 mole percent) 3-(2,2,3,3,4,4,5,5,6,6,7,7-dodecafluorotridecoxy)propylmethylsiloxane-co-(75 mole percent) (dimethylsiloxane), 30 parts N,N-dimethylacrylamide and 0.5 percent Darocur™ 1173 as the UV initiator was cast into 1 mm thick films by UV initiated polymerization. The resultant 3 inch by 5 inch films were cut into 20 mm discs and were extracted in isopropanol for 16 hours. The discs were dried overnight under 20 mm Hg vacuum at 90° C. for 16 hours and cut into lens shape by cryo-lathing techniques. The lenses were optically clear and possessed excellent handling characteristics. In the dry state the lenses were capable of being folded into a “taco shell” or a cylindrical shape. These lenses when placed into a borate buffer solution immediately expanded and the lens shape was recovered.

### EXAMPLE 6

### Preparation of Copolymer Based on DP100 Methacrylate End-Capped poly[3-(2,2,3,3,4,4,5,5,6,6,7,7-dodecafluorotridecoxy)propylmethylsiloxane]-co-(dimethylsiloxane)

A formulation consisting of 80 parts of a DP100 synthesis of methacrylate end-capped poly (25 mole percent) 3-(2,2,3,3,4,4,5,5,6,6,7,7-dodecafluorotridecoxy)propylmethylsiloxane-co-(75 mole percent) (dimethylsiloxane), 20 parts N,N-dimethylacrylamide and 0.5 percent Darocur™ 1173 as the UV initiator was cast into 1 mm thick films by UV initiated polymerization. The resultant 3 inch by 5 inch films were cut into 20 mm discs and were extracted in isopropanol for 16 hours. The discs were dried overnight under 20 mm Hg vacuum at 90° C. for 16 hours and cut into lens shape by cryo-lathing techniques. The lenses were optically clear and possessed excellent handling characteristics. In the dry state the lenses were capable of being folded into a “taco shell” or a cylindrical shape. These lenses when placed into a borate buffer solution immediately expanded and the lens shape was recovered.

Ophthalmic devices such as but not limited to IOLs manufactured using the hydrogel compositions of the present invention can be of any design capable of being rolled or folded for implantation through a relatively small surgical incision, i.e., 3.0 mm or less. For example, ophthalmic devices such as IOLs typically comprise an optic portion and one or more haptic portions. The optic portion reflects light onto the retina and the permanently attached haptic portions hold the optic portion in proper alignment within an eye. The haptic portions may be integrally formed with the optic portion in a one-piece design or attached by staking, adhesives or other methods known to those skilled in the art in a multipiece design.

The subject ophthalmic devices, such as for example IOLs, may be manufactured to have an optic portion and haptic portions made of the same or differing materials. Preferably, in accordance with the present invention, both the optic portion and the haptic portions of the IOLs are made of one or more hydrogel compositions of the present invention. Alternatively, however, the IOL optic portion and haptic portions may be manufactured from differing materials and/or differing hydrogel compositions of the present invention, such as described in U.S. Pat. Nos. 5,217,491 and 5,326,506, each incorporated herein in its entirety by reference. Once the particular material or materials are selected, the same is either cast in molds of the desired shape or cast in the form of rods and lathed or machined into disks. If cast in the form of rods and lathed or machined into disks, the disks are lathed or machined into IOLs at low temperatures below the glass transition temperature(s) of the material(s). The IOLs, whether molded or machined/lathed, are then cleaned, polished, packaged and sterilized by customary methods known to those skilled in the art.

In addition to IOLs, the hydrogel compositions of the present invention are also suitable for use in the manufacture of other ophthalmic devices such as but not limited to contact lenses, keratoprostheses, capsular bag extension rings, corneal inlays, corneal rings or like devices.

IOLs manufactured using the unique hydrogel compositions of the present invention are used as customary in the field of ophthalmology. For example, in a surgical procedure, an incision is placed in the cornea of an eye. Most commonly, through the corneal incision the natural lens of the eye is removed (aphakic application) such as in the case of a cataractous natural lens. An IOL is then inserted into the anterior chamber, posterior chamber or lens capsule of the eye prior to closing the incision. However, the subject ophthalmic devices may be used in accordance with other surgical procedures known to those skilled in the field of ophthalmology.

While there is shown and described herein monomers and hydrogel compositions, methods of producing the monomers and hydrogel compositions, methods of producing ophthalmic devices using the hydrogel compositions and methods of using ophthalmic devices manufactured from the hydrogel compositions, all in accordance with the present invention, it will be manifest to those skilled in the art that various modifications may be made without departing from the spirit and scope of the underlying inventive concept. The present invention is likewise not intended to be limited to particular devices described herein except insofar as indicated by the scope of the appended claims.

We claim:

1. A fluoro side-chain methacrylate end-capped silicone monomer comprising: 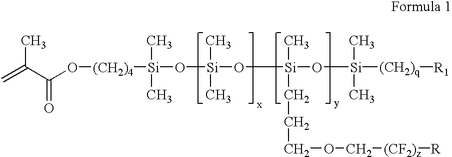
wherein R is selected from the group consisting of hydrogen and fluorine; R₁ is an activated unsaturated polymerizable group; x is an integer less than 51; y is an integer less than 101; z is an integer less than 21; and q is an integer less than 11.

2. A hydrogel composition produced through the copolymerization of one or more monomers of claim 1 with one or more hydrophilic monomers.

3. A hydrogel composition produced through the copolymerization of one or more monomers of claim 1 with one or more hydrophilic monomers selected from the group consisting of N,N-dimethylacrylamide, acrylamide, acrylic acic, 2-hydroxyethyl methacrylate, glyceryl methacrylate, N-vinylpyrrolidone, diacetone acrylamide, 2-acrylamido-2-methylpropanesulfonic acid and its salts, 2-(meth)acryloyloxyethylsulfonic acid and its salts, 3-(meth)acryloyloxypropylsulfonic acid and its salts, styrenesulfonic acid and its salts, carboxystyrene and its salts, 3-(meth)acrylamidopropyl-N,N-dimethylamine and its salts, 2-(meth)acryloylethyl-N,N-dimethylamine and its salts and methacrylic acid.

4. A method of producing a hydrogel composition using the fluoro side-chain methacrylate end-capped silicone monomer of claim 1 comprising:
polymerizing a fluoro side-chain methacrylate end-capped silicone monomer with a hydrophilic monomer and an initiator.

5. A method of producing ophthalmic devices from the hydrogel compositions of claim 2 or 3 comprising:
casting one or more hydrogel compositions in the form of a rod;
lathing or machining said rod into disks; and
lathing or machining said disks into ophthalmic devices.

6. A method of producing ophthalmic devices from the hydrogel compositions of claim 2 or 3 comprising:
pouring one or more polymeric compositions into a mold prior to curing;
curing said one or more hydrogel compositions; and
removing said one or more hydrogel compositions form said mold following curing thereof.

7. A method of using ophthalmic devices of claim 5 or 6 comprising:
making an incision in the cornea of an eye; and
implanting said ophthalmic device within the eye.

8. The method of claim 5, 6 or 7 wherein said ophthalmic device is an intraocular lens or a corneal inlay.

9. The method of claim 5 or 6 wherein said ophthalmic device is a contact lens.

10. A hydrogel composition produced through the copolymerization of one or more monomers of claim 1 and one or more hydrophilic monomers with one or more strengthening agents.

11. The hydrogel composition of claim 10 wherein said one or more strengthening agents are selected from the group consisting of cycloalkyl acrylates and methacrylates.

12. A hydrogel composition produced through the copolymerization of one or more monomers of claim 1 and one or more hydrophilic monomers with one or more crosslinking agents.

13. The hydrogel composition of claim 12 wherein said one or more crosslinking agents are selected from the group consisting of diacrylates and dimethacrylates of triethylene glycol, butylene glycol, neopentyl glycol, hexane-1,6-diol, thio-diethylene glycol and ethylene glycol, poly(ethylene glycol), trimethylolpropane triacrylate, N,N′-dihydroxyethylene bisacrylamide, diallyl phthalate, triallyl cyanurate, divinylbenzene; ethylene glycol divinyl ether, N,N-methylene-bis-(meth)acrylamide, divinylbenzene and divinylsulfone.

14. The hydrogel composition of claim 2 or 3 wherein said composition expands upon hydration of 15 percent weight/volume or greater.

15. The hydrogel composition of claim 2 or 3 wherein said composition expands upon hydration of 45 percent weight/volume or greater.

16. A method of using ophthalmic devices of claim 5 or 6 comprising:
making an incision in the cornea of an eye; and
implanting said ophthalmic device within the eye causing said ophthalmic device to hydrate and expand.

17. The monomer of claim 1 wherein said R₁ group is selected from the group consisting of methacrylates, methacrylamides, vinyl carbamates and maleonates.
